(19) United States
(12) Patent Application Publication
(10) Pub. No.: US 2018/0192673 A1
(43) Pub. Date: Jul. 12, 2018

(54) Beverage Cooling and Flavoring System

(71) Applicant: O2COOL, LLC, Chicago, IL (US)

(72) Inventor: Joshua A. Lefkovitz, Akron, OH (US)

(21) Appl. No.: 15/868,757

(22) Filed: Jan. 11, 2018

Related U.S. Application Data
(60) Provisional application No. 62/445,521, filed on Jan. 12, 2017.

(51) Int. Cl. A23L 2/56; A23G 9/26; A23G 9/22; B65D 1/06; B65D 47/06; B65D 85/72

(52) U.S. Cl. CPC A23L 2/56; A23G 9/26; A23G 9/221; F25D 31/002; B65D 47/06; B65D 85/72; A23V 2002/00; B65D 1/06

(57) ABSTRACT

A bottle has a top opening, a bottom opening, and a removable bottom. The removable bottom is coupleable to the bottle to seal and unseal the bottom opening and has a stem projecting outward from the removable bottom. The removable bottom is configured to be removed from the bottle and inserted into a mold such that a frozen solid is formable about the stem. The removable bottom is further configured to be coupleable to the bottle such that the frozen solid and the stem are positioned within the bottle and the bottom opening is sealed.

### CROSS-REFERENCE TO RELATED APPLICATIONS

This application claims the benefit of U.S. Provisional Application No. 62/445,521, filed Jan. 12, 2018, which is hereby incorporated by reference in its entirety.

### STATEMENT REGARDING FEDERALLY SPONSORED RESEARCH OR DEVELOPMENT

Not Applicable.

### APPENDIX

Not Applicable.

### BACKGROUND

### Field

This disclosure relates generally to liquid drinking vessels for cooling a drinking liquid and, more particularly, to a liquid drinking vessels for infusing a frozen flavored liquid into drinking liquid.

### Related Art

The trend for consumption of carbonated soft drinks or similar sugary beverages is on the downswing. Consumer preferences are moving away from carbonated soft drinks (CSDs) and toward beverages they perceive as healthier, such as energy drinks and non-carbonated beverages like teas, bottled water and functional beverages.

A part of this trend is the continuous infusion of extracted juices or comminuted foodstuffs into a beverage liquid. Products that provide infusion of flavors or juices with water fulfill the need for the infusion of natural foodstuff extracts as flavorings in water as a healthy, natural, desired alternative to CSD's.

In practical use, the functioning of infusion water bottles require multiple steps: extraction of flavorings within the beverage container; addition of water into the beverage container; and then the addition of ice cube(s) into the beverage container to chill the blended flavored water for consumption in a more palatable condition.

Given this, a need exists for new and improved methods of combining flavorings, water and/or ice for portable beverage consumption.

Some methods and devices are known that incorporate various mechanisms for freezing flavored liquids, infusing flavorings into liquids or cooling beverages without dilution are known. These include, for example:

U.S. Pat. No. 4,091,632, titled “Beverage Cooling Device having Consumable Foodstuff Therein”, discloses an ice mold circumscribing a drinking straw. Essentially including an ice cube anchored to a straw with no real separation between flavor and water, orifices in the ice mold allow the frozen contents to thaw and communicate into the drinking vessel slowly.

U.S. Pat. No. 6,182,452, titled “Method and Device for Cooling and Enhancing the Flavor of Beverages”, describes the use of a sealed packet of ice that can be inserted into a beverage for cooling without diluting.

U.S. Pat. No. 7,124,603, titled “Ice Retaining Shot Glass Systems”, provides a double walled shot glass for forming ice outside and in contact with the liquid container.

U.S. Pat. No. 8,151,577, titled “Frozen Beverage Ice”, describes an apparatus for making a beverage slurry that includes the insertion of a freezing device into the beverage container (as opposed to inserting the beverage into a freezer).

U.S. Patent Application Publication 2008/0196434, entitled “Beverage Cooling Device”, describes a clip connected to the rim of a drinking vessel that holds an immersed but sealed cooling body at the bottom of the beverage (thereby preventing it from floating).

U.S. Pat. No. 9,017,749, titled “Flavored Straw with a Flavor Delivery System”, provides a solid flavor material molded about a straw. The passage of fluid through the straw dissolves the flavor material and adds to the beverage being consumed.

U.S. Pat. No. 9,247,756, titled “Device for Simultaneous Consumption of a Fluid and a Frozen Substance”, discloses a device that creates a popsicle-like frozen confection. A plunger is then used to drive an alcoholic beverage upward through a tube formed within the frozen component so that the user can inject liquid along with the frozen confection. The plunger handle appears to be for injection liquid while eating, rather than forming a liquid contained center.

U.S. Pat. No. 9,272,444, titled “Ice Mold”, discloses a mold that allows for the formation of spherical ice.

U.S. Pat. No. D642,022, titled “Insert for a Comestible Maker”, discloses an ornamental design for a popsicle mold forming three popsicles.

U.S. Pat. No. D690,169, titled “Ice Pop Maker”, discloses an ornamental design for a popsicle mold forming six popsicles. Both of these are exemplary of a number of frozen mold designs assigned to Propeller, Inc. of Hoboken, N.J. that appear to be used along with the method and apparatus of U.S. Pat. No. 8,057,207 for the quick making of frozen treats (3-10 minutes is described).

U.S. Patent Application Publication 2014/0065267 describes a mold for forming a frozen pop or molded treat in which a drinkable liquid or edible solid center is created within the treat. A core space is created inside a frozen molded body. Liquid (drinks or alcoholic beverages) or solid (cake, candy or other edible) is then transferred into the core.

U.S. Pat. No. 8,307,670, titled “Ice Holding Device”, describes an ice forming bucket in which the ice is formed into pockets radially about a cylinder rather than within a conventional flat tray.

U.S. Pat. No. 7,093,459, titled “Removable Cooling Device and Integrated Vessels”, describes stemware that has a cavity in the base for inserting a specialty shaped ice element. The cavity is formed between the stem and the bowl of the drinking glass.

U.S. Pat. No. 5,357,761, titled “Universal Thermal Insert for Beverage Containers” describes a thermal insert designed for insertion into and retention by a sport water bottle.

U.S. Pat. No. D743,741, titled “beverage and Popsicle Container”, describes an ornamental embodiment of a container. There is no specific disclosure as to any mechanism within the container that would teach the placement of popsicles inside a beverage.

U.S. Patent Application Publication 2013/0232992, titled “Novel Ice and Method of Manufacturing Ice”, describes a method for freezing a solid (fruit, vegetable or foodstuff) within the ice for flavor addition and visual appeal. This reference specifically identify fruit and citrus as a food molded within the ice. It further anticipates manufacturing ice to be used cooperatively with water bottles and sports bottles. However, the limit of disclosure for the bottle combination is to create a form factor of limited girth to allow insertion into such a container. The creation of narrow, cylindrical ice is further described in U.S. Pat. No. 6,345,802 for a “Shaped Ice Article and Article for Making Same”.

U.S. Patent Application Publication 2006/0127555, titled “Frozen Additive for Use with a Heated Beverage”, describes the general process of making ice cubes of the same composition as a heated beverage (coffee, tea, hot cider, etc.) so as to allow or cooling without dilution.

It is preferable that a system, method and device provides for the cooling of a beverage liquid along with the simultaneous continuous infusion of flavorings. Consequently, a need has been felt for providing an apparatus and method which beverage cooling and flavoring system that provides such functions.

### SUMMARY

It is thus an object of the present disclosure to provide a beverage cooling and/or flavoring system.

It is a further object of the present disclosure to provide a method of continuously cooling and/or infusing a flavoring into a beverage liquid.

It is still a further object of the present disclosure to provide a system and method in which the flavoring and cooling of the beverage fluid are combined.

The present disclosure provides a system, apparatus and method for the contemporaneous cooling and flavoring of a beverage liquid. A liquid drinking vessel is provided forming a drinking volume having a removable, resealable lower vessel containment. The lower vessel containment functions additionally as a mold base for a frozen mold in which secondarily functions to seal an ice mold. The frozen mold essentially forms a part of the drinking vessel that is attachable and removable: removable in order to facilitate creation of a flavored ice anchored thereto; and attachable in order to both provide leak-proof containment in a manner that anchors the flavored ice within the liquid volume in order to provide continuous physical communication.

The ice mold may be used to freeze a flavored liquid. The frozen flavored liquid may then be removed from the mold and inserted within the drinking vessel drinking volume in a manner anchored to the vessel within the liquid and forcibly submerged, with the frozen flavoring intact. Once water is added, the liquid drinking vessel is thereby continuously infused with flavor as well as simultaneously chilled.

In one aspect, a method for cooling a potable liquid includes filling a mold with a first liquid. The mold has an opening configured to receive the liquid. The method further includes placing a stem into the first liquid. The stem is configured to extend into the first liquid. The method further includes freezing the first liquid around the stem to form a first frozen solid around the stem, and removing the first frozen solid and stem from the mold. The method further includes inserting the stem and the first frozen solid into a bottle. The bottle has a bottom opening and a top opening, and the stem and first frozen solid is inserted into the bottle via the bottom opening. The stem is coupled to a bottle closure and projects outward from the bottle closure. The method further includes securing the bottle closure to the bottle to seal the bottom opening with the stem projecting upward into the bottle. The method still further includes at least partially filling the bottle with a second liquid through the top opening of the bottle.

In another aspect, a method for cooling a potable liquid uses a bottle having a first opening and a second opening. The method includes removing from a mold a first frozen solid where the first frozen solid is frozen about a stem. The method further includes inserting the stem and the first frozen solid into the bottle through the first opening. The stem is coupled to a bottle closure and projects outward from the bottle closure. The method further includes securing the bottle closure to the bottle to seal the first opening with the stem projecting upward into the bottle. The method still further includes at least partially filling the bottle with a second liquid through the second opening.

In another aspect, a system for cooling a potable liquid using a bottle includes a bottle, a stem, and a mold. The bottle has a top, a bottom, a first opening, a second opening, a first bottle finish, a second bottle finish, and a first bottle closure. The first opening is at the bottom of the bottle, and the second opening is at the top of the bottle. The first bottle finish corresponds with the first opening, and the second bottle finish corresponds with the second opening. The first bottle closure is configured to releasably engage with the first bottle finish to seal and unseal the first opening. The stem is coupled to a base and projects outward from the base. The stem is configured to engage with a frozen solid, and the base is capable of being releasably coupled to the first bottle closure such that the first bottle closure is coupled to the first bottle finish with the stem and a frozen liquid about the stem positioned within the bottle. The mold has an interior volume defined by the mold and an opening sized to permit the stem. The opening is further sized to be covered by the base when the stem is inserted into the interior volume of the mold. The mold is further configured to contain a liquid within the interior volume about the stem such that the liquid may be frozen about the stem. The stem and the mold are configured to cooperate such that the frozen solid is formable about the stem with the stem in the interior volume of the mold. The stem, the first bottle closure, and the bottle are configured to cooperate such that the stem including the frozen solid about the stem is removable from the mold and coupleable to the first bottle closure by the base. The first bottle closure is securable to the bottle such that frozen solid is placed within the bottle.

In another aspect, a bottle has a top opening, a bottom opening, and a removable bottom. The removable bottom is coupleable to the bottle to seal and unseal the bottom opening and has a stem projecting outward from the removable bottom. The removable bottom is configured to be removed from the bottle and inserted into a mold such that a frozen solid is formable about the stem. The removable bottom is further configured to be coupleable to the bottle such that the frozen solid and the stem are positioned within the bottle and the bottom opening is sealed.

Further features of the disclosed embodiments will become apparent in the course of the following description.

### BRIEF DESCRIPTION OF THE DRAWINGS

The advantages and features of the present disclosure will become better understood with reference to the following more detailed description and claims taken in conjunction with the accompanying drawings, in which like elements are identified with like symbols.

FIG. 1 is a front elevation view of a beverage cooling system according to one embodiment.

FIG. 2 is a front perspective view of the system shown in FIG. 1.

FIG. 3A is a side perspective view of a multiple ice mold system for use with the system shown in FIG. 1.

FIG. 3B is a bottom perspective view of a mold base for use with the mold system shown in FIG. 3A;

FIG. 4A is an exploded schematic view of portions of the beverage cooling system according to an alternative embodiment.

FIG. 4B is a cross-sectional view taken along line 4B-4B of FIG. 4A.

FIG. 4C is a side view of a bottle of the system shown in FIG. 4A.

FIG. 4D is a side view of a mold base for use with the system shown in FIG. 4A.

FIG. 4E is a top view of the mold base shown in FIG. 4D.

FIG. 5A a partial side view of the system shown in FIG. 4A.

FIG. 5B is a side view of a second mold for use with the system shown in FIG. 4A.

FIG. 6 is a side view of a bottle of the system shown in FIG. 4A.

FIG. 7 is a side view of a frozen solid created by the system shown in FIG. 4A.

FIG. 8 is a side view of the frozen solid of FIG. 7 positioned within a bottle.

FIG. 9 is a side view of a two part frozen solid positioned within a bottle.

### DETAILED DESCRIPTION

Before explaining the present disclosure in detail, it is important to understand that the disclosure is not limited in its application to the details of the construction illustrated and the steps described herein. The disclosure is capable of other embodiments and of being practiced or carried out in a variety of ways. It is to be understood that the phraseology and terminology employed herein is for the purpose of description and not of limitation.

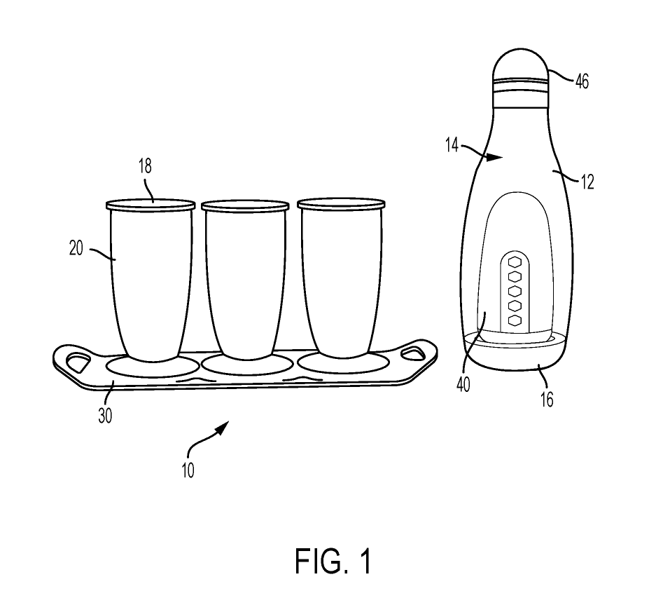

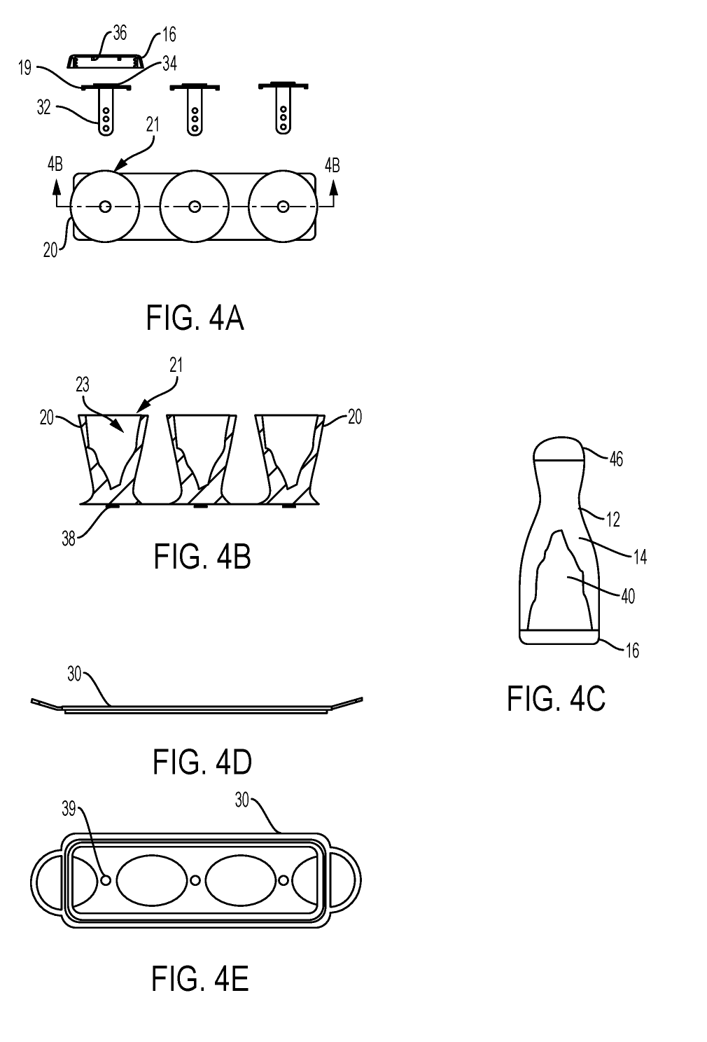

Referring now to the drawings, wherein like reference numerals indicate the same parts throughout the several views, and specifically in conjunction with FIG. 1 through FIG. 3, a system, apparatus, and method for cooling and/or flavoring of a beverage liquid (“system”), generally noted as 10, is shown according to the preferred embodiment. A liquid drinking vessel 12 (e.g., a bottle) is provided forming a drinking volume 14 having a removable, resealable lower vessel containment 16 (e.g., a bottom bottle closure). For example, and without limitation, the bottom bottle closure 16 is threaded to cooperate with a threaded bottom bottle finish 17. In some embodiments, the lower vessel containment 16 functions additionally as a mold base 18 for a frozen mold 20 in which it secondarily functions to seal the ice mold 20. In alternative embodiments discussed in greater detail below with reference to FIGS. 4A-9, the lower vessel containment 16 is releasably coupleable to a base 19 that functions to seal the mold 20. A plurality of nested molds 24 (as described in greater detail below) may be provided to form a multi-layer solute to allow for continuous phase changing melted flavoring material to simultaneously flavor and chill the fluid in the drinking volume 14. In other words, a plurality of molds 24, 25 may be used in succession to create a frozen solid in two or more parts with a first part 27 positioned within a second part 29. The two parts 27, 29 may be the same or may differ (e.g., in formulation, in color, etc.).

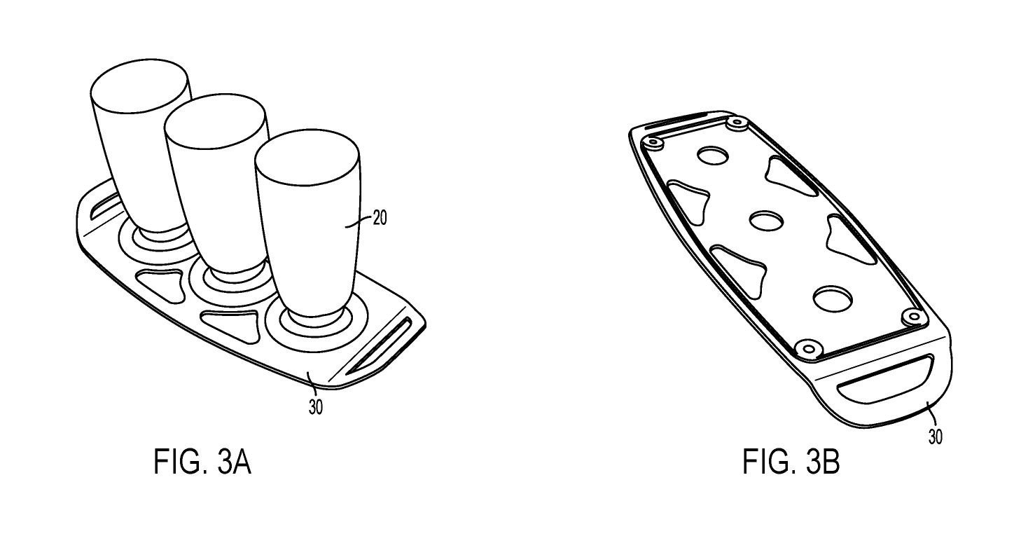

As shown in conjunction with FIGS. 3A and 3B, the ice molds 20 are shown in greater detail. While it should be apparent to a person having ordinary skill in the relevant art, in light of the present teachings, that the present disclosure is not limited to any one particular configuration of ice mold 20, one particular exemplary configuration is shown in which a plurality of generally narrow, cylindrical molds 20 are supported by and attached to a planar mold base 30. Such a system allows a user to create multiple “popsicle” like flavored ice elements by filling each mold 20 with a liquid, flavored beverage, affix them to the top of the mold base 30, and then place within a freezer to allow for the freezing of the mold contents 40.

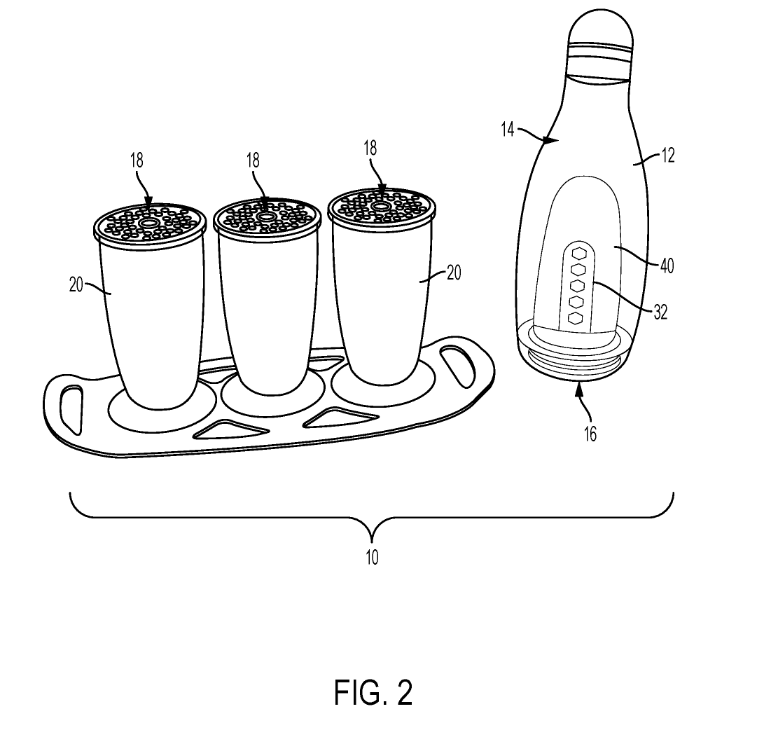

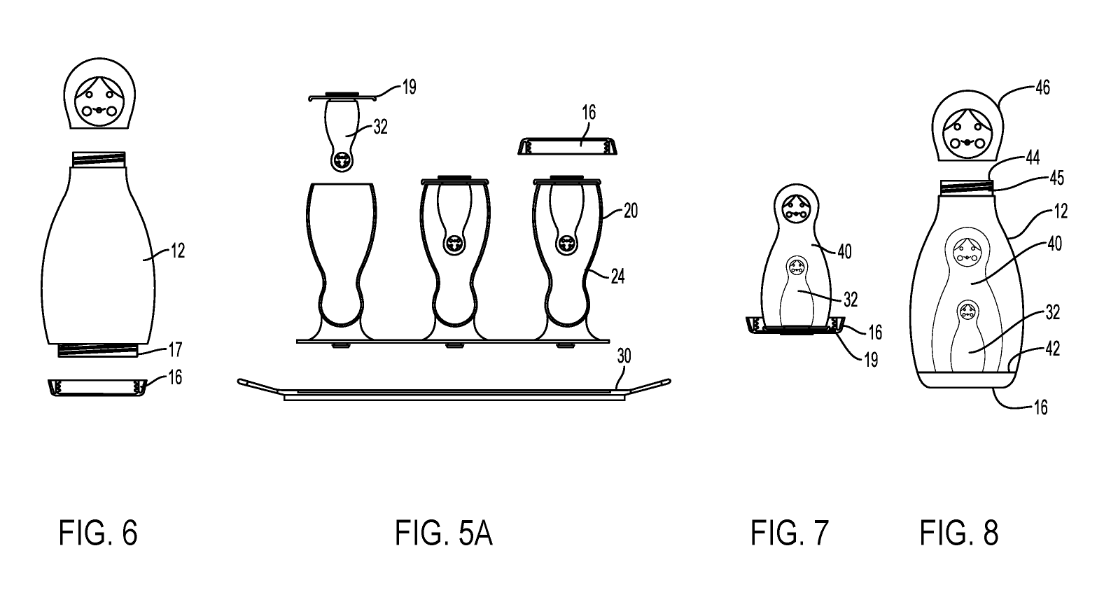

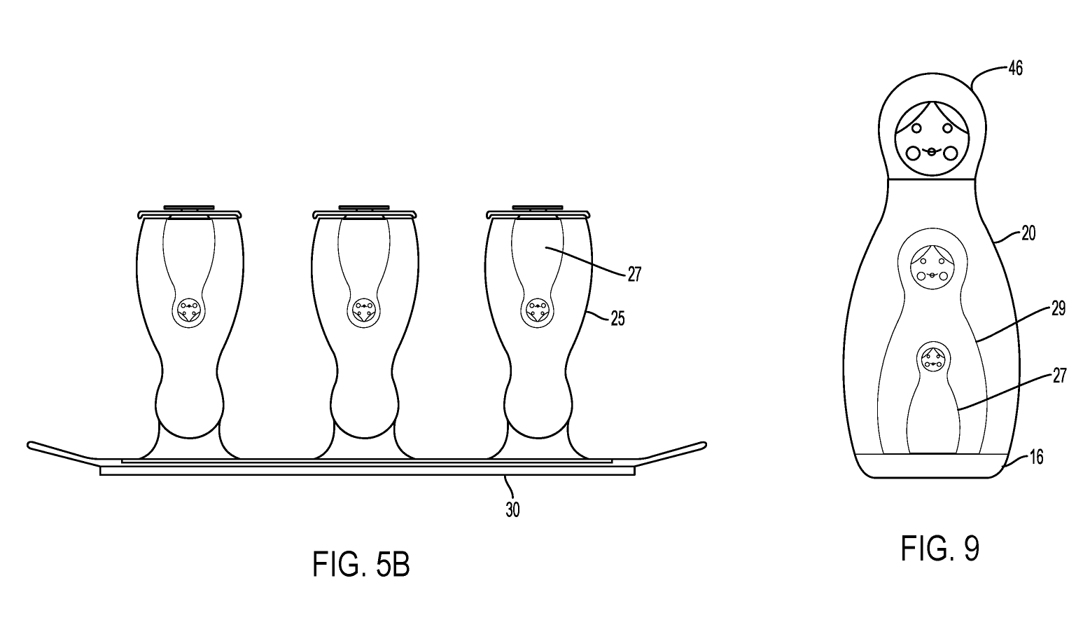

As shown in conjunction with FIGS. 4A through 5B, the ice molds 20 are shown in greater detail. In being used to freeze a flavored (or unflavored) liquid, the liquid is introduced into one or more molds 20. While various materials of construction may be suitable, the use of a flexible silicone in creation of the molds 20 is found to be useful in allowing for removal of the frozen shaped mold contents. In some embodiments, such as those depicted with reference to FIGS. 1 and 2, a vessel containment 16 is used to at least partially seal the opening 21 of each mold 20, and a vertical support stick 32 may be further supported on an inside surface of the containment 16 and dependant into the volume of a mold 20. In alternative embodiments, a base 19 is used to at least partially seal the opening 21 of the mold 20. The base 19 is coupled to the stem 32 and may position the stem 32 within the interior volume 23 of the mold 20 such that the liquid may be frozen about the stem 32. The base 19 is releasably coupleable to the bottom bottle closure 16. The base 19 includes a first portion 34 of a fastener and the bottom bottle closure 16 includes a second portion 36 of the fastener. The two portions cooperate to allow the base 19 to be releasably coupled to the bottom bottle closure 16. For example, and without limitation, the fastener may be a bayonet fastener, twist lock fastener, quarter turn fastener, snap fastener, or the like.

Such a configuration allows a frozen popsicle like frozen solid 40 to be created about the stem 32 and affixed to the vessel containment 16 that functions as a liquid drinking vessel base. This configuration also allows for the creation of a plurality of frozen solid 40 and stem 32 combinations while using a single bottom bottle closure 16. In such embodiments, the mold(s) 20 may include male snap fit fasteners 38 and the mold base 30 (e.g., a freezing tray) includes openings 39 configured to receive the male snap fit fasteners 38.

In operation, the present disclosure is used to cool or cool and flavor a beverage. As shown in conjunction with FIG. 6-9, a user creates a number of shaped, flavored ice elements within each mold. In one embodiment, the bottom of the drinking vessel 16 is used to seal each ice mold 20. In alternative embodiments, the base 19 seals the mold 20. The user fills the mold 20 with a first liquid (e.g., water, tea, coffee, or the like) and places the stem 32 into the first liquid and at least partially within the mold 20. The user then places the mold 20 and the stem 32 in an area with sufficiently cool temperatures to freeze the first liquid (e.g., in a freezer). This freezes the first liquid around and about the stem 32 to form a frozen solid 40. After the contents of the mold 20 are frozen, they may then be removed from the mold 20 while still attached to the bottom bottle closure 16 or the stem 32 and base 19. The user then inserts the stem 32 and the frozen solid 40 into the bottle 12 through a bottom opening 42 of the bottle 12 and secures the bottom bottle closure 16 to the bottle to seal the bottom opening 42. When the bottom bottle closure 16 is attached and sealed to the bottom of a drinking vessel 12, the frozen solid 40 (e.g., a flavored popsicle) is inserted within the drinking volume 14 of the drinking vessel 12 with the frozen solid 40.

A user may then at least partially fill the bottle 12 and the drinking volume 14 with a second liquid through a top opening 44 of the bottle 12. The second liquid may be of the same composition as the first liquid used to make the frozen solid 40 or may be of a different composition. Filling the bottle 12 with the second liquid causes the second liquid to directly contact the frozen solid 40. The bottle 12 further includes a top bottle closure 46 that is capable of sealing and unsealing the top opening 44 by engaging with a top bottle finish 45 (e.g., threads) about the top opening 44. As depicted, the top bottle closure 46 may be a cap. Alternatively, the top bottle closure 46 is a drink spout or other suitable closure. After sealing the top opening 44 with the top bottle closure 46, a user may shake the bottle 12 to mix the contents and/or transport the bottle 12 securely.

The liquid drinking vessel 12 may being filled with a second liquid such as a beverage liquid, allows the beverage to be continuously infused with flavor as well as simultaneously chilled as the frozen solid 40 melts The liquid drinking vessel 12 is thereby continuously infused with flavor as well as simultaneously chilled.

The same operation may be used in succession with the plurality of molds 24, 25 to create a frozen solid in two or more parts with a first part 27 positioned within a second part 29.

As various modifications could be made in the constructions and methods herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above-described exemplary embodiments, but should be defined only in accordance with the following claims appended hereto and their equivalents.

It should also be understood that when introducing elements of the present disclosure in the claims or in the above description of exemplary embodiments of the disclosure, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

What is claimed is:

1. A method for cooling a potable liquid, the method comprising:
filling a mold with a first liquid, the mold having an opening configured to receive the liquid;
placing a stem into the first liquid, the stem configured to extend into the first liquid;
freezing the first liquid around the stem to form a first frozen solid around the stem;
removing the first frozen solid and stem from the mold;
inserting the stem and the first frozen solid into a bottle, the bottle having a bottom opening and a top opening, the stem and first frozen solid being inserted into the bottle via the bottom opening, the stem being coupled to a bottle closure and projecting outward from the bottle closure, and securing the bottle closure to the bottle to seal the bottom opening with the stem projecting upward into the bottle; and
at least partially filling the bottle with a second liquid through the top opening of the bottle.

2. A method as set forth in claim 1 wherein the first liquid and the second liquid are of the same composition.

3. A method as set forth in claim 1 wherein the first liquid is of a first composition and the second liquid is of a second composition, the first and second compositions being different.

4. A method as set forth in claim 1 further comprising releasably coupling the stem to the bottle closure.

5. A method as set forth in claim 4 wherein the stem is coupled to a first portion of a fastener and the bottle closure is coupled to a second portion of the fastener, the first portion and the second portion being releasably coupleable to one another, and wherein releasably coupling the stem to the bottle closure comprises coupling the stem to the bottle closure using the fastener.

6. A method as set forth in claim 5 wherein the fastener is a bayonet fastener.

7. A method as set forth in claim 1 wherein at least partially filling the bottle with the second liquid through the top opening causes the second liquid to directly contact with the first frozen solid.

8. A method for cooling a potable liquid using a bottle having a first opening and a second opening, the method comprising:
removing from a mold, a first frozen solid, the first frozen solid frozen about a stem;
inserting the stem and the first frozen solid into the bottle through the first opening, the stem coupled to a bottle closure and projecting outward from the bottle closure, and securing the bottle closure to the bottle to seal the first opening with the stem projecting upward into the bottle; and
at least partially filling the bottle with a second liquid through the second opening.

9. A method as set forth in claim 8 wherein at least partially filling the bottle with the second liquid through the second opening causes the second liquid to come into contact with the first frozen solid.

10. A method as set forth in claim 8 wherein the first opening is in a bottom of the bottle, and wherein the second opening is in a top of the bottle.

11. A system for cooling a potable liquid using a bottle, the system comprising:
a bottle having a top and a bottom and comprising a first opening, a second opening, a first bottle finish, a second bottle finish, and a first bottle closure, the first opening being at the bottom of the bottle, the second opening being at the top of the bottle, the first bottle finish corresponding with the first opening, the second bottle finish corresponding the with the second opening, and the first bottle closure being configured to releasably engage with the first bottle finish to seal and unseal the first opening;
a stem coupled to a base and projecting outward from the base, the stem configured to engage with a frozen solid, the base capable of being releasably coupled to the first bottle closure such that the first bottle closure is coupled to the first bottle finish with the stem and a frozen liquid about the stem positioned within the bottle; and
a mold having an interior volume defined by the mold and an opening sized to permit the stem, the opening further sized to be covered by the base when the stem is inserted into the interior volume of the mold, the mold configured to contain a liquid within the interior volume about the stem such that the liquid may be frozen about the stem, wherein the stem and the mold are configured to cooperate such that the frozen solid is formable about the stem with the stem in the interior volume of the mold, and wherein the stem, the first bottle closure, and the bottle are configured to cooperate such that the stem including the frozen solid about the stem is removable from the mold and coupleable to the first bottle closure by the base, and the first bottle closure is securable to the bottle such that frozen solid is placed within the bottle.

12. A system as set forth in claim 11 wherein the first bottle finish comprises a plurality of threads, and wherein the first bottle closure is threaded to engage with the plurality of threads of the first bottle finish.

13. A system as set forth in claim 11 wherein the opening and interior volume of the mold are sized such that liquid frozen about the stem is sized to be insertable within the first opening of the bottle and the bottle.

14. A system as set forth in claim 11 wherein the base includes a first portion of a twist lock fastener and the first bottle closure includes a second portion of a twist lock fastener, the first and second portions configured to cooperate such that the base is capable of being releasably coupled to the first bottle closure.

15. A system as set forth in claim 11 wherein the mold further includes a male snap fit fastener, and wherein the system further comprises a freezing tray having a plurality of openings configured to receive the male snap fit fastener, the freezing tray capable of being coupled to a plurality of molds.

16. A system as set forth in claim 11 wherein the first bottle closure and the stem are configured to position the frozen liquid within the bottle such that liquid entering the bottle from the second opening is permitted to contact the frozen liquid.

17. A system as set forth in claim 11 further comprising a second bottle closure, the second bottle closure configured to releasably engage with the second bottle finish to seal and unseal the second opening.

18. A system as set forth in claim 16 wherein the second bottle closure is a drink spout.

19. An apparatus comprising:
a bottle having a top opening, a bottom opening, and a removable bottom, the removable bottom being coupleable to the bottle to seal and unseal the bottom opening and having a stem projecting outward from the removable bottom, the removable bottom configured to be removed from the bottle and inserted into a mold such that a frozen solid is formable about the stem, and the removable bottom further configured to be coupleable to the bottle such that the frozen solid and the stem are positioned within the bottle and the bottom opening is sealed.

20. An apparatus as set forth in claim 19 further comprising a frozen solid coupled to and positioned about the stem, the removable bottom coupled to the bottle with the stem and frozen solid positioned within the bottle.
